(19) United States
(12) Patent Application Publication
(10) Pub. No.: US 2025/0271488 A1
(43) Pub. Date: Aug. 28, 2025

(54) PARALLEL ELECTRON SWARM PARAMETER CALCULATION METHOD TAKING ION DYNAMICS INTO CONSIDERATION, AND RELATED APPARATUS

(71) Applicant: XI'AN JIAOTONG UNIVERSITY, Xi'an (CN)

(72) Inventors: Boya ZHANG, Xi'an (CN); Mai HAO, Xi'an (CN); Xingwen LI, Xi'an (CN); Yuyang YAO, Xi'an (CN)

(73) Assignee: XI'AN JIAOTONG UNIVERSITY, Xi'an (CN)

(21) Appl. No.: 19/208,104

(22) Filed: May 14, 2025

Related U.S. Application Data
(63) Continuation of application No. PCT/CN2022/133243, filed on Nov. 21, 2022.

(30) Foreign Application Priority Data
Nov. 14, 2022 (CN) 2022114255890

(51) Int. Cl. G01R 31/12; G06F 30/23; G06F 30/25; H05H 1/00

(52) U.S. Cl. CPC G01R 31/1281; G06F 30/23; G06F 30/25; H05H 1/0006

(57) ABSTRACT

Disclosed are a parallel electron swarm parameter calculation method taking ion dynamics into consideration, and related apparatus. The method includes: measuring a discharge current waveform of gas under a reduced field intensity, and obtaining a measured current waveform; establishing an electron avalanche space-time development model of a coupled electron charge density and different types of ion charge densities; computing the discharge current waveform of the gas under the reduced field intensity through a finite volume method according to the electron avalanche space-time development model, and obtaining a computed current waveform; and computing the electron swarm parameters of the gas under the reduced field intensity with a minimum deviation between the measured current waveform and the computed current waveform as an optimization target through a genetic algorithm.

### CROSS-REFERENCE TO RELATED APPLICATIONS

The application claims priority to Chinese patent application No. 2022114255890, filed on Nov. 14, 2022, the entire contents of which are incorporated herein by reference.

### TECHNICAL FIELD

The present disclosure belongs to the technical field of plasma, and relates to a parallel electron swarm parameter calculation method taking ion dynamics into consideration, and related apparatus.

### BACKGROUND

As an important processing technology, the plasma technology has been applied as a significant role to a wide range of fields. It has gradually developed into a key technology in microelectronics, semiconductors, materials, aerospace, metallurgy and other industries, which is widely used in biology, medicine, clinical and environmental fields.

Plasma is a collection of plentiful particles, including electrons, ions, and neutral molecules. Collision behaviors between the electrons and the neutral molecules under an electric field serve as a key dimension to describe properties of the plasma. These collision behaviors include ionization, attachment, detachment, ion conversion and other processes. A reaction rate coefficient, an electron drift velocity, an electron diffusion coefficient and other parameters describing ionization and attachment are collectively referred to as electron swarm parameters, which are important input parameters for numerical simulation of the plasma.

The electron swarm parameters can be computed by solving the Boltzmann equation, and corresponding collision cross-section data need to be input. These collision cross-section data are generally difficult to obtain. The electron swarm parameters can also be measured through swarm experiments. Electron swarm experiments were developed gradually and widely in the 1970s. This type of experiments can be used to measure discharge parameters and electron transport coefficients of pre-discharge (low temperature) plasma of mixed gas, and to fit microscopic parameters such as a collision cross-section of gas. These reaction rate coefficients, transport coefficients and collision cross-sections are all key basic parameters for discharge plasma simulation in gas. According to a generation method for initial electrons and corresponding experimental principles, the electron swarm experiments can be divided into steady-state Townsend (SST) experiments and pulsed Townsend (PT) experiments. The SST experiment is relatively simple in method, and its parameter model describing an electron avalanche is also relatively simple. Thus, only ionization and attachment coefficients can be obtained, and electron transport parameters cannot be obtained. The PT experiment is to release the initial electrons through ultraviolet laser pulse, and form a single electron avalanche that moves to an anode in the electric field, forming a pulsed current waveform. The PT experiment requires high precision of apparatuses, and needs a more complex physical model to describe a space-time development process of the electron avalanche. Thus, ionization and attachment coefficients can be obtained, and drift and diffusion coefficients of electrons can be obtained.

However, at present, most analytical models for pulsed Townsend experiments are only based on an electron dynamics model considering ionization and attachment reactions, and only an ion dynamics analysis model is established for a small amount of gas. In this way, it is difficult to accurately obtain a detachment rate coefficient and an ion conversion rate coefficient through the PT experiments. Inaccurate and incomplete electron swarm parameters as input parameters of numerical simulation of the plasma will make simulation results under different gas pressures and different electric fields questionable. Ion dynamics is to add a process of detachment and ion conversion based on electron dynamics. As shown in results, a special configuration of a large amount of gas probably leads to complex reactions such as three-body collision attachment, dissociative ionization, dissociative attachment, detachment and ion conversion during electron avalanche development. Thus, it is crucial for plasma technology research to develop the advanced PT experimental technology, establish an electron avalanche space-time development model considering an ion dynamics process, and accurately measure the electron swarm parameters of the gas.

In addition, some mere ion dynamics models are generally solved through analytical methods, leading to great computation difficulty and only adaption to a single type of gas. Thus, it is urgent to establish a universal, fast and accurate computation method for electron swarm parameters in consideration of ion dynamics.

### SUMMARY

An objective of the present disclosure is to solve problems in the prior art, and provide a fast, accurate and universal parallel electron swarm parameter calculation method taking ion dynamics into consideration, and related apparatus based on a pulsed Townsend experiment, and related apparatuses.

In order to achieve the objective, the present disclosure uses the following technical solution:

In a first aspect, the present disclosure provides a parallel electron swarm parameter calculation method taking ion dynamics into consideration. The method includes the following steps:
measuring a discharge current waveform of gas under a reduced field intensity, and obtaining a measured current waveform;
establishing an electron avalanche space-time development model of a coupled electron charge density and different types of ion charge densities;
computing the discharge current waveform of the gas under the reduced field intensity through a finite volume method according to the electron avalanche space-time development model, and obtaining a computed current waveform; and
computing the electron swarm parameters of the gas under the reduced field intensity with a minimum deviation between the measured current waveform and the computed current waveform as an optimization target through a genetic algorithm.

In a second aspect, the present disclosure provides a parallel electron swarm parameter calculation system taking ion dynamics into consideration. The system includes:
a waveform measurement module configured to measure a discharge current waveform of gas under a reduced field intensity, and obtain a measured current waveform;
a model establishment module configured to establish an electron avalanche space-time development model of a coupled electron charge density and different types of ion charge densities;
a waveform computation module configured to compute the discharge current waveform of the gas under the reduced field intensity through a finite volume method according to the electron avalanche space-time development model, and obtain a computed current waveform; and
a parameter computation module configured to compute the electron swarm parameters of the gas under the reduced field intensity with a minimum deviation between the measured current waveform and the computed current waveform as an optimization target through a genetic algorithm.

In a third aspect, the present disclosure provides a computer device. The computer device includes a memory, a processor, and a computer program stored in the memory and runnable on the processor. When the computer program is executed by the processor, steps of the method are implemented.

In a fourth aspect, the present disclosure provides a computer-readable storage medium. The computer-readable storage medium stores a computer program. When the computer program is executed by a processor, steps of the method are implemented.

Compared with the prior art, the present disclosure has the beneficial effects:

Based on Matlab and compute unified device architecture (CUDA) platforms, the present disclosure uses the genetic algorithm, regards the minimum deviation between the pulsed Townsend measured current waveform and a simulated current waveform as the optimization target, further considers the ion dynamics based on electron dynamics, and applies a parallel algorithm to accelerate optimization to obtain electron swarm parameters of various types of gas, thus providing basic data for plasma simulation conveniently, accurately and quickly. The present disclosure has the following advantages:

First, the present disclosure further considers ion dynamics based on electron dynamics, that is, comprehensively considers processes such as ionization, attachment, detachment and ion conversion that may occur in gas discharge, such that complete electron swarm parameters can be obtained, and complete input data can be provided for plasma simulation.

Second, the present disclosure uses a finite volume method to solve a discharge current waveform, so as to provide great flexibility for current computation while ensuring computation accuracy, adapt to reaction paths of various types of gas under electron and ion dynamics, and improve universality of a computation method.

Third, the present disclosure uses a genetic algorithm to solve the electron swarm parameters, and the genetic algorithm is a widely used global optimization algorithm and ensures accuracy of computation results.

Fourth, the present disclosure uses a parallel algorithm based on the CUDA platform when computing a current waveform, which greatly improves a computation velocity and achieves rapidity.

Further, computation of the electron swarm parameters in the present disclosure is based on a pulsed Townsend experimental platform that is a high-precision experimental apparatus for studying gas discharge parameters, which ensures reliability of computation results in the present disclosure.

Further, division of a time infinitesimal and a space infinitesimal is small enough to ensure convergence of current waveform computation.

Further, when computing the current waveform, the present disclosure fully considers drift movement of electrons, diffusion movement of electrons and mutual transformation between various particles, thus ensuring correctness of computation results.

### BRIEF DESCRIPTION OF DRAWINGS

In order to more clearly describe technical solutions of examples of the present disclosure, the accompanying drawings required in the examples will be described briefly below. It should be understood that the following accompanying drawings illustrate only some examples of the present disclosure and thus should not be construed as a limitation on the scope. For those of ordinary skill in the art, other relevant accompanying drawings can be obtained from these accompanying drawings without any creative effort.

FIG. 1 is a flowchart of a parallel computation method for electron swarm parameters in the present disclosure;

FIG. 2 is a schematic diagram of a parallel computation system for electron swarm parameters in the present disclosure;

FIG. 3 is a schematic structural diagram of a discharge space in the present disclosure;

FIG. 4 is a schematic diagram of a particle drift operation in the present disclosure;

FIG. 5 shows a discharge current waveform of air measured through a pulsed Townsend experiment under d=20 mm, p=10 kPa, T=300 K and E/N=110 Td, where (a) denotes a pulsed Townsend discharge current waveform in a time scale of 0 ns to 600 ns, and (b) denotes a pulsed Townsend discharge current waveform in a time scale of 600 ns to 50 μs;

FIG. 6 shows electron and ion dynamics reaction paths of air; and

FIG. 7 shows a waveform corresponding to finally computed electron swarm parameters, which is compared with an experimental measurement waveform, where (a) denotes a pulsed Townsend discharge computation and experiment current waveform in a time scale of 0 ns to 600 ns, and (b) denotes a pulsed Townsend discharge computation and experiment current waveform in a time scale of 600 ns to 50 μs.

### DETAILED DESCRIPTION OF THE EMBODIMENTS

To make objectives, technical solutions and advantages of examples of the present disclosure clearer, the technical solutions in the examples of the present disclosure will be clearly and completely described below in conjunction with the accompanying drawings in the examples of the present disclosure. Obviously, the described examples are some examples rather than all the examples of the present disclosure. Generally, components of the examples of the present disclosure described and shown in the accompanying drawings may be arranged and designed in various manners.

Thus, the following detailed description of the examples of the present disclosure provided in the accompanying drawings is not intended to limit the scope of the claimed present disclosure, and is merely representative of selected examples of the present disclosure. Based on the examples of the present disclosure, all other examples obtained by those of ordinary skill in the art without making creative efforts fall within the protection scope of the present disclosure.

It should be noted that like numerals and letters denote like items in the following accompanying drawings, and therefore, once an item is defined in one accompanying drawing, it does not need to be further defined and explained in the subsequent accompanying drawings.

In the examples of the present disclosure, it should be noted that the orientation or positional relationship indicated by terms such as “upper”, “lower”, “horizontal” and “inside” is based on the orientation or positional relationship shown in the accompanying drawings, or the orientation or positional relationship of a product conventionally placed during use, which is merely for ease of description and simplification of the present disclosure, instead of indicating or implying that the apparatus or element referred to must have a particular orientation and be constructed and operative in a particular orientation, and thus cannot be construed as a limitation on the present disclosure. Moreover, the terms such as “first” and “second” are used merely to distinguish between descriptions and cannot be understood as indication or implication of relative importance.

Further, the term “horizontal” does not indicate that components are required to be absolutely horizontal, and indicates that components may be slightly inclined. For instance, the term “horizontal” merely indicates that a direction is horizontal relative to “vertical”, and does not indicate that a structure must be completely horizontal and indicates that the structure may be slightly inclined.

In the description of the examples of the present disclosure, it should be also noted that unless expressly specified and defined otherwise, the terms “arrange”, “mount”, “connect”, and “connection” are to be construed broadly. For instance, they can denote fixed connection, detachable connection or integral connection, denote mechanical connection or electric connection; denote direct connection or indirect connection by means of an intermediate medium; or denote communication between interiors of two elements. For those of ordinary skill in the art, specific meanings of the terms in the present disclosure may be understood according to specific circumstances.

The present disclosure will be further described in detail below with reference to the accompanying drawings.

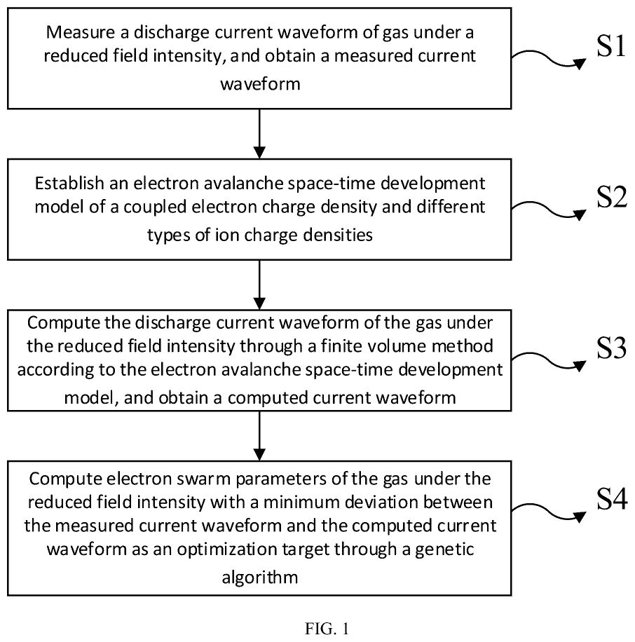

With reference to FIG. 1, the examples of the present disclosure disclose a parallel electron swarm parameter calculation method taking ion dynamics into consideration. The method includes the following steps:

S1, a discharge current waveform of gas under a reduced field intensity is measured, and a measured current waveform is obtained.

The discharge current waveform of the measured gas under the reduced field intensity is measured based on a pulsed Townsend experimental platform. The reduced field intensity E/N is a ratio of an electric field intensity E to a molecular number density N. E=U/d, N=p/k_{B}T. U denotes a voltage applied between electrodes, d denotes an electrode spacing, p denotes a pressure intensity, k_{B} denotes a Boltzmann constant, and T denotes an experimental temperature. Total duration of the discharge current waveform is about 50 μs, and duration of a current waveform led by initial electrons is about 200 ns.

S2, an electron avalanche space-time development model of a coupled electron charge density and different types of ion charge densities is established.

The electron avalanche space-time development model is as follows:

$$( \frac{\partial }{\partial t} + ω \frac{\partial }{\partial x} ) ρ ( x , t ) = M ρ ( x , t ) + ( \begin{matrix}{D}_{L} \\ \vec{0}\end{matrix} ) \frac{{\partial }^{2}}{{\partial }^{2} x} ρ ( x , t )$$

M denotes an n×n order particle transformation matrix, t denotes time, x denotes a one-dimensional space, D_{L} denotes an electron diffusion coefficient, and ρ denotes a column vector of a charge density of each particle as follows:

$$ρ = ( \begin{matrix}{ρ}_{1} ( x , t ) \\ {ρ}_{2} ( x , t ) \\ ⋮ \\ {ρ}_{n} ( x , t )\end{matrix} )$$

ω denotes a drift velocity of each particle as follows:

$$ω = ( \begin{matrix}{ω}_{1} \\ {ω}_{2} \\ ⋮ \\ {ω}_{n}\end{matrix} )$$

n indicates that n types of particles are provided, and a first type of particles are generally electrons, that is, ρ₁(x, t)=ρₑ(x, t), and ω₁=ωₑ.

S3, if a reaction rate coefficient of mutual transformation between particles is known, the discharge current waveform of the gas under the reduced field intensity is computed through a finite volume method according to the electron avalanche space-time development model, and a computed current waveform is obtained. Specifically,

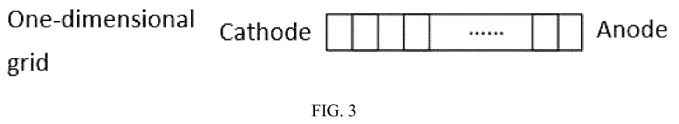

(1) A discharge space is divided into Nₓ one-dimensional grids, where left boundaries of the grids are cathodes, and right boundaries of the grids are anodes; and as shown in FIG. 3, a length of each grid is h=d/Nₓ, and a time infinitesimal is defined as Δt=h/ωₑ.

(2) When t=0, initial electrons are released in first cells near the cathodes, where a number of the initial electrons is n₀.

(3) A particle drift operation is performed as follows:

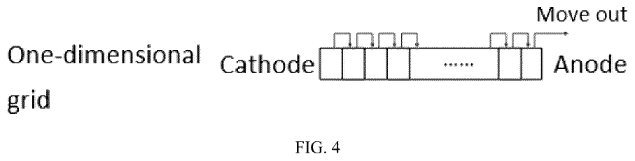

As shown in FIG. 4, under a definition of the time infinitesimal in (1), a drift operation of the electrons is to move a number of electrons in each cell to a next cell, and move electrons in a last cell near the anode out of the one-dimensional space; and for ions, a drift velocity of the ions is much less than that of the electrons, so the ions do not drift in each time infinitesimal. The ions drift once each time after the electrons drift ωₑ/ωᵢₒₙ times, and ωᵢₒₙ denotes a drift velocity of the ions.

(4) An inter-particle transformation operation is performed, specifically:

$$ρ ( x , t + Δ t ) = M ρ ( x , t ) Δ t + ρ ( x , t )$$

ρ denotes a column vector of a charge density of each particle; x denotes the one-dimensional space; t denotes time; Δt denotes a time infinitesimal, and Δt=h/ωₑ; ωₑ denotes the drift velocity of the electrons; h denotes a length of each grid, and h=d/Nₓ; d denotes an electrode spacing; Nₓ denotes a number of one-dimensional grids; and M denotes an n×n order particle transformation matrix.

(5) An electron diffusion operation is performed as follows:
for 2nd to (Nₓ−1)th cells, diffusion in each cell is from two adjacent cells, specifically:

$${ρ}_{e} ( x , t + Δ t ) = {ρ}_{e} ( x , t ) + \frac{{D}_{L}}{{h}^{2}} ( {ρ}_{e} ( x - h , t ) - 2 {ρ}_{e} ( x , t ) + {ρ}_{e} ( x + h , t ) ) Δ t$$

ρₑ denotes an electron charge density, and D_{L} denotes an electron diffusion coefficient.

For a first cell, electrons diffused to a cathode are bounced back to the first cell as follows:

$${ρ}_{e} ( x , t + Δ t ) = {ρ}_{e} ( x , t ) + \frac{{D}_{L}}{{h}^{2}} ( - {ρ}_{e} ( x , t ) + {ρ}_{e} ( x + h , t ) ) Δ t$$

For a last cell, electrons diffused to an anode are absorbed by the anode as follows:

$${ρ}_{e} ( x , t + Δ t ) = {ρ}_{e} ( x , t ) + \frac{{D}_{L}}{{h}^{2}} ( {ρ}_{e} ( x - h , t ) - 2 {ρ}_{e} ( x , t ) ) Δ t$$

(6) A current value I_{c0}(t) under a current time infinitesimal is computed, specifically:

$${I}_{c 0} ( t ) = {\sum }_{j = 1}^{n} \vert {ω}_{j} \vert {\sum }_{i = 1}^{{N}_{x}} {ρ}_{j} ( {x}_{i} , t )$$

ρⱼ denotes a charge density of a j-th type of particles, ωⱼ denotes a drift velocity of the j-th type of particles, and xᵢ denotes an i-th grid.

(7) Steps (3) to (6) are repeated to compute a current value under a next time infinitesimal until total duration of the discharge current waveform is reached.

(8) A computed current is converted to a same order of magnitude as a measured current, specifically:

$${I}_{c} ( t ) = \frac{{\sum }_{k = 1}^{Tol \sum } ( {I}_{c 0} ( {t}_{k} ) {IK}_{m}}{{\sum }_{k = 1}^{Tol} {( {I}_{c 0} ( {t}_{k} ) )}^{2} \frac{{I}_{{c}_{0}} ( t )}{{n}_{0}}}$$

Tol denotes a total number of time infinitesimals, I_{c} denotes a computed current value, tₖ denotes a time infinitesimal, and Iₘ denotes a measured current value.

S4, the electron swarm parameters of the gas under the reduced field intensity are computed with a minimum deviation between the measured current waveform and the computed current waveform as an optimization target through a genetic algorithm. For the step that the electron swarm parameters of the gas under the reduced field intensity are computed, a parallel algorithm is used to accelerate obtainment of the electron swarm parameters of the gas under the reduced field intensity.

The step that the electron swarm parameters of the gas under the reduced field intensity are computed includes the following steps:

(I) Reaction rate coefficients of electron dynamics and ion dynamics are used as decision variables, and an initial population of the genetic algorithm is generated through an Optimization toolbox in Matlab.

(II) With the optimization target of a deviation between the measured current waveform and the computed current waveform, the optimization target is fitness of individuals in the population, and the less the deviation, the greater the fitness as follows:

$$fitness = {\sum }_{k = 1}^{Tol} {W}_{j} ( {I}_{c} ( {t}_{k} ) - {Ik}_{m}^{2}$$

Tol denotes a total number of time infinitesimals, I_{c} denotes a computed current value, tₖ denotes a time infinitesimal, Iₘ denotes a measured current value, and Wⱼ denotes a weight value;

(III) Fitness of each individual in the population is computed; and computation of individual fitness requires computation of a corresponding current under each group of decision variables (that is, genes). Due to a high drift velocity of the electrons and long simulation time, a current computation process is very time-consuming, such that parallel computation improves efficiency. The current computation process follows S3, and parallel computation needs to be performed on a graphics processing unit (GPU). Specifically,
\textcircled{1} a central processing unit (CPU) end transmits genes of each individual in the population to the GPU, and the genes are the decision variables;
\textcircled{2} a compute unified device architecture (CUDA) creates a resource required for computation;
\textcircled{3} each warp at a CUDA end is responsible for computing one current waveform, and a computation process is performed according to steps (1) to (8);
\textcircled{4} a computing resource is released; and
\textcircled{5} a computed waveform is transmitted back to the CPU end, and the fitness of each individual in the population is computed according to step (II).

(IV) Whether the fitness reaches an expected value or an upper iteration limit is determined, if yes, a result is output and a computed current result is displayed, if no, step (V) is executed.

(V) The Optimization toolbox in matlab is used to perform selection, crossover and mutation operations on the population, and step (III) is returned to.

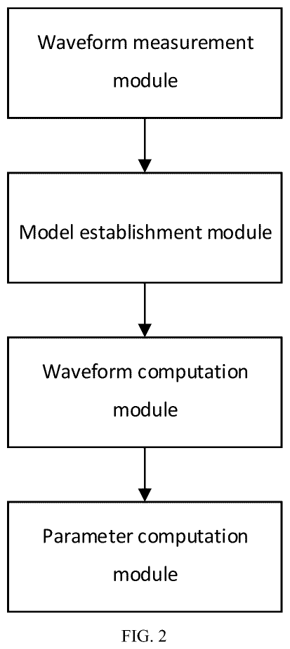

With reference to FIG. 2, the examples of the present disclosure disclose a parallel electron swarm parameter calculation system taking ion dynamics into consideration. The system includes:
a waveform measurement module configured to measure a discharge current waveform of gas under a reduced field intensity, and obtain a measured current waveform;
a model establishment module configured to establish an electron avalanche space-time development model of a coupled electron charge density and different types of ion charge densities;
a waveform computation module configured to compute the discharge current waveform of the gas under the reduced field intensity through a finite volume method according to the electron avalanche space-time development model, and obtain a computed current waveform; and
a parameter computation module configured to compute the electron swarm parameters of the gas under the reduced field intensity with a minimum deviation between the measured current waveform and the computed current waveform as an optimization target through a genetic algorithm.

### Example: With Air as an Instance

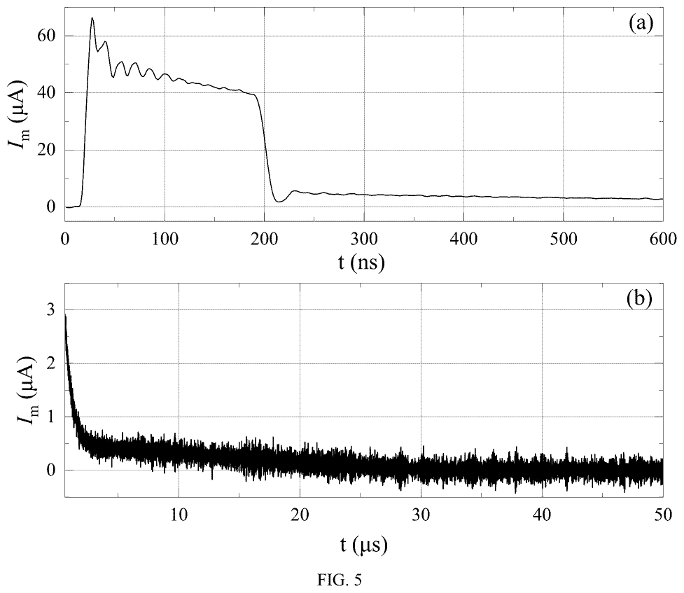

Step 1, based on a pulsed Townsend experimental platform, a discharge current waveform of air under a reduced field intensity E/N=110 Td is measured as shown in FIG. 5, where d=20 mm, p=10 kPa, and T=300 K. Total duration of the discharge current waveform is 50 μs, and duration of a current waveform led by initial electrons is about 200 ns.

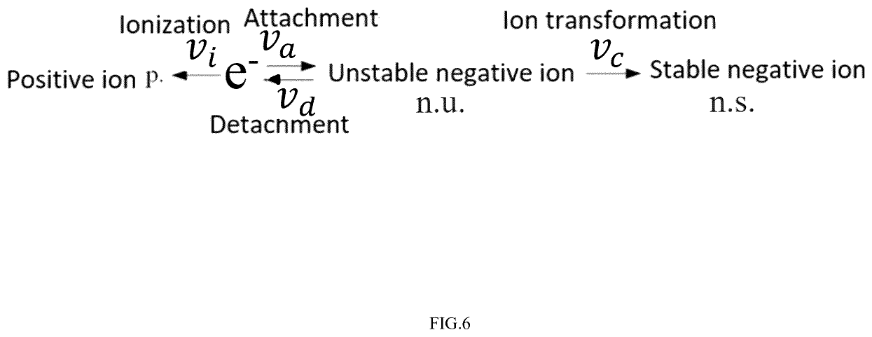

Step 2, according to known electron and ion dynamics reaction paths of air as shown in FIG. 6, in consideration of transport and mutual transformation processes of electrons and all ions, an electron avalanche space-time development model of a coupled electron charge density and different types of ion charge densities is established. The equation is described as follows:

$$( \frac{\partial }{\partial t} + ω \frac{\partial }{\partial x} ) ρ ( x , t ) = M ρ ( x , t ) + ( \begin{matrix}{D}_{L} \\ \vec{0}\end{matrix} ) \frac{{\partial }^{2}}{{\partial }^{2} x} ρ ( x , t )$$

$$where$$

$$ρ = ( \begin{matrix}{ρ}_{e} ( x , t ) \\ {ρ}_{n . u .} ( x , t ) \\ {ρ}_{n . s .} ( x , t ) \\ {ρ}_{p .} ( x , t )\end{matrix} ) ,$$

$$ω = ( \begin{matrix}{ω}_{e} \\ {ω}_{n . u .} \\ {ω}_{n . s .} \\ {ω}_{p .}\end{matrix} ) ,$$

$$M = ( \begin{matrix}{v}_{i} - {v}_{a} & 0 & {v}_{d} & 0 \\ {v}_{i} & 0 & 0 & 0 \\ {v}_{a} & 0 & - {v}_{d} - {v}_{c} & 0 \\ 0 & 0 & {v}_{c} & 0\end{matrix} )$$

which indicates that 4 types of particles are provided, e denotes electrons, n.u. denotes unstable negative ions, n.s. denotes stable negative ions, and p. denotes positive ions. M denotes a particle transformation matrix, where νᵢ denotes an ionization rate, νₐ denotes an attachment rate, ν_{d} denotes a detachment rate, and ν_{c} denotes an ion conversion rate. In the examples, ωₑ=1.08×10⁵ m/s, ω_{n.u.}=1.24×10³ m/s, ω_{n.u.}=8.68×10² m/s, ω_{p.}=5.5×10² m/s, and D_{L}=1.41 m² s⁻¹.

Step 3, if a reaction rate coefficient of mutual transformation between particles is known, the discharge current waveform of the gas under the reduced field intensity E/N=110 Td is computed through a finite volume method, where a one-dimensional space is divided into 128 grids, and no of initial electrons is equal to 10⁷.

Step 4, obtainment of the electron swarm parameters of air under the reduced field intensity E/N=110 Td is accelerated through a parallel algorithm with a minimum deviation between a pulsed Townsend measured current waveform and a computed current waveform as an optimization target through a genetic algorithm. Reaction rate coefficients of electron dynamics and ion dynamics are used as decision variables (that is, genes), and an initial population of the genetic algorithm is generated through an Optimization toolbox in Matlab. A number of initial populations is 1000. Specifically, the decision variables are as follows:

Ω=[vᵢ,vₐ,v_{d},v_{c}]
each computation of current waveforms is based on CUDA parallel acceleration. After 50 iterations through the genetic algorithm, the electron swarm parameters of air under 10 kPa and the reduced field intensity E/N=110 Td in consideration of ion dynamics may be computed. Final computation results are as follows:

$${v}_{i} = 4.21 \times {10}^{6} m / s$$

$${v}_{a} = 6.64 \times 1 {0}^{6} m / s$$

$${v}_{d} = 9.88 \times {10}^{5} m / s$$

$${v}_{c} = 9.04 \times 1 {0}^{5} m / s$$

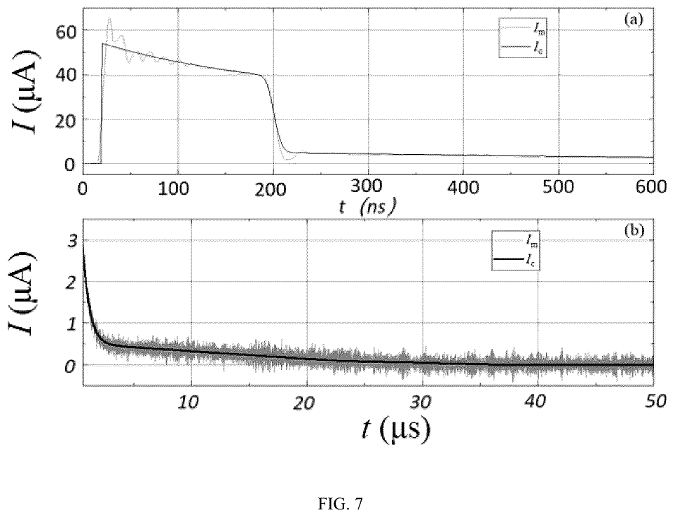

A waveform corresponding to the finally computed electron swarm parameters is shown in FIG. 7, and a computed waveform is compared with an experimental measured waveform in FIG. 7.

The examples of the present disclosure provide a computer device. The computer device of the example includes: a processor, a memory and a computer program stored in the memory and runnable on the processor. When the computer program is executed by the processor, steps of each of the method examples are implemented. Or, when the computer program is executed by the processor, functions of all modules/units of each of the apparatus examples are achieved.

The computer program may be divided into one or more modules/units. The one or more modules/units are stored in the memory and are executed by the processor, so as to complete the present disclosure.

The computer device may be a desktop computer, a notebook computer, a handheld computer, a cloud server, or another computing device. The computer device may include, but is not limited to, the processor and the memory.

The processor may be a central processing unit (CPU) or another general-purpose processor, a digital signal processor (DSP), an application specific integrated circuit (ASIC), a field-programmable gate array (FPGA) or other programmable logic devices, a discrete gate or a transistor logic device, a discrete hardware component, etc.

The memory may be used to store the computer program and/or modules. The processor achieves various functions of the computer device through running or execution of the computer program and/or the modules stored in the memory, and invoking of data stored in the memory.

If modules/units integrated on the computer device are implemented in a form of software functional units and sold or used as independent products, the modules/units may be stored in a computer-readable storage medium. Based on such an understanding, all or some procedures in the methods in the examples implemented by the present disclosure may be completed through a computer program instructing related hardware. The computer program may be stored in one computer-readable storage medium. When the computer program is executed by the processor, steps of each of the method examples may be implemented. The computer program includes computer program codes. The computer program codes may be in a form of source codes, object codes or executable files, or some intermediate forms. The computer-readable medium may include: any entity or apparatus capable of carrying the computer program codes, a recording medium, a USB flash drive, a mobile hard disk drive, a magnetic disk, an optical disk, a computer memory, a read-only memory (ROM), a random access memory (RAM), an electrical carrier signal, a telecommunication signal, a software distribution medium, etc. It should be noted that appropriate additions or deletions may be made to the content included in the computer-readable medium according to requirements of the legislation in a jurisdictional area and patent practice. For instance, in some jurisdictional areas, according to the legislation and patent practice, the computer-readable medium does not include an electrical carrier signal or a telecommunication signal.

What are described above are merely preferred examples of the present disclosure and are not intended to limit the present disclosure. Those skilled in the art can make various modifications and changes to the present disclosure. Any modification, equivalent substitution, improvement, etc. within the spirit and principle of the present disclosure shall fall within the protection scope of the present disclosure.

What is claimed is:

1. A parallel electron swarm parameter calculation method taking ion dynamics into consideration, comprising the following steps:
measuring a discharge current waveform of gas under a reduced field intensity, and obtaining a measured current waveform;
establishing an electron avalanche space-time development model of a coupled electron charge density and different types of ion charge densities;
computing the discharge current waveform of the gas under the reduced field intensity through a finite volume method according to the electron avalanche space-time development model, and obtaining a computed current waveform; and
computing the electron swarm parameters of the gas under the reduced field intensity with a minimum deviation between the measured current waveform and the computed current waveform as an optimization target through a genetic algorithm.

2. The parallel electron swarm parameter calculation method taking ion dynamics into consideration according to claim 1, wherein the measuring a discharge current waveform of gas under a reduced field intensity is based on a pulsed Townsend experimental platform; and the reduced field intensity E/N is a ratio of an electric field intensity E to a molecular number density N, wherein E=U/d, N=p/k_{B}T, U denotes a voltage applied between electrodes, d denotes an electrode spacing, p denotes a pressure intensity, k_{B} denotes a Boltzmann constant, and T denotes an experimental temperature.

3. The parallel electron swarm parameter calculation method taking ion dynamics into consideration according to claim 1, wherein the electron avalanche space-time development model is as follows:
$$( \frac{\partial }{\partial t} + ω \frac{\partial }{\partial x} ) ρ ( x , t ) = M ρ ( x , t ) + ( \begin{matrix}{D}_{L} \\ \vec{0}\end{matrix} ) \frac{{\partial }^{2}}{{\partial }^{2} x} ρ ( x , t )$$
M denoting an n×n order particle transformation matrix, t denoting time, x denoting a one-dimensional space, D_{L} denoting an electron diffusion coefficient, and ρ denoting a column vector of a charge density of each particle as follows:
$$ρ = ( \begin{matrix}{ρ}_{1} ( x , t ) \\ {ρ}_{2} ( x , t ) \\ ⋮ \\ {ρ}_{n} ( x , t )\end{matrix} )$$
ω denoting a drift velocity of each particle as follows:
$$ω = ( \begin{matrix}{ω}_{1} \\ {ω}_{2} \\ ⋮ \\ {ω}_{n}\end{matrix} )$$
n indicating that n types of particles are provided.

4. The parallel electron swarm parameter calculation method taking ion dynamics into consideration according to claim 1, wherein the computing the discharge current waveform of the gas under the reduced field intensity through a finite volume method comprises:
(1) dividing a discharge space into Nₓ one-dimensional grids, wherein left boundaries of the grids are cathodes, and right boundaries of the grids are anodes;
(2) releasing, when t=0, initial electrons in first cells near the cathodes, wherein a number of the initial electrons is n₀;
(3) performing a particle drift operation:
moving electrons in last cells near the anodes out of a one-dimensional space, and then moving a number of electrons in each cell to a next cell, wherein ions drift once each time after electrons drift ωₑ/ωᵢₒₙ times, ωᵢₒₙ denotes a drift velocity of the ions, and ωₑ denotes a drift velocity of the electrons;
(4) performing an inter-particle transformation operation in each cell, specifically:
$$ρ ( x , t + Δ t ) = M ρ ( x , t ) Δ t + ρ ( x , t )$$
ρ denoting a column vector of a charge density of each particle; x denoting the one-dimensional space; t denoting time; Δt denoting a time infinitesimal, and Δt=h/ωₑ; ωₑ denoting the drift velocity of the electrons; h denoting a length of each grid, and h=d/Nₓ; d denoting an electrode spacing; Nₓ denoting a number of one-dimensional grids; and M denoting an n×n order particle transformation matrix;
(5) performing an electron diffusion operation:
wherein for 2nd to (Nₓ−1)th cells, diffusion in each cell is from two adjacent cells, specifically:
$${ρ}_{e} ( x , t + Δ t ) = {ρ}_{e} ( x , t ) + \frac{{D}_{L}}{{h}^{2}} ( {ρ}_{e} ( x - h , t ) - 2 {ρ}_{e} ( x , t ) + {ρ}_{e} ( x + h , t ) ) Δ t$$
ρₑ denoting an electron charge density, and D_{L} denoting an electron diffusion coefficient;
for a first cell, electrons diffused to a cathode are bounced back to the first cell as follows:
$${ρ}_{e} ( x , t + Δ t ) = {ρ}_{e} ( x , t ) + \frac{{D}_{L}}{{h}^{2}} ( - {ρ}_{e} ( x , t ) + {ρ}_{e} ( x + h , t ) ) Δ t$$
for a last cell, electrons diffused to an anode are absorbed by the anode as follows:
$${ρ}_{e} ( x , t + Δ t ) = {ρ}_{e} ( x , t ) + \frac{{D}_{L}}{{h}^{2}} ( {ρ}_{e} ( x - h , t ) - 2 {ρ}_{e} ( x , t ) ) Δ t$$
(6) computing a current value I_{c0}(t) under a current time infinitesimal, specifically:
$${I}_{c 0} ( t ) = {\sum }_{j = 1}^{n} \vert {ω}_{j} \vert {\sum }_{i = 1}^{{N}_{x}} {ρ}_{j} ( {x}_{i} , t )$$
ρⱼ denoting a charge density of a j-th type of particles, ωⱼ denoting a drift velocity of the j-th type of particles, and xᵢ denoting an i-th grid;
(7) repeating steps (3) to (6) to compute a current value under a next time infinitesimal until total duration of the discharge current waveform is reached; and
(8) converting a computed current to a same order of magnitude as a measured current, specifically:
$${I}_{c} ( t ) = \frac{{\sum }_{k = 1}^{Tol \sum } ( {I}_{c 0} ( {t}_{k} ) {Ik}_{m}}{{\sum }_{k = 1}^{Tol} {( {I}_{c 0} ( {t}_{k} ) )}^{2} \frac{{I}_{{c}_{0}} ( t )}{{n}_{0}}}$$
Tol denoting a total number of time infinitesimals, I_{c} denoting a computed current value, tₖ denoting a time infinitesimal, and Iₘ denoting a measured current value.

5. The parallel electron swarm parameter calculation method taking ion dynamics into consideration according to claim 4, wherein for the computing the electron swarm parameters of the gas under the reduced field intensity, a parallel algorithm is used to accelerate obtainment of the electron swarm parameters of the gas under the reduced field intensity.

6. The parallel electron swarm parameter calculation method taking ion dynamics into consideration according to claim 5, wherein the computing the electron swarm parameters of the gas under the reduced field intensity comprises:
(I) using reaction rate coefficients of electron dynamics and ion dynamics as decision variables, and generating an initial population of the genetic algorithm through an Optimization toolbox in Matlab;
(II) using a deviation between the measured current waveform and the computed current waveform as the optimization target as follows:
$$fitness = {\sum }_{k = 1}^{Tol} {W}_{j} ( {I}_{c} ( {t}_{k} ) - {Ik}_{m}^{2}$$
the optimization target being fitness of individuals in the population, Tol denoting the total number of time infinitesimals, I_{c} denoting the computed current value, tₖ denoting a time infinitesimal, Iₘ denoting the measured current value, and Wⱼ denoting a weight value; de
(III) computing fitness of each individual in the population;
(IV) determining whether the fitness reaches an expected value or an upper iteration limit, if yes, outputting a result and displaying a computed current result, and if no, executing step (V); and
(V) using the Optimization toolbox in matlab to perform selection, crossover and mutation operations on the population, and returning to step (III).

7. The parallel electron swarm parameter calculation method taking ion dynamics into consideration according to claim 5, wherein the parallel algorithm performs parallel computation on a graphics processing unit (GPU) as follows:
\textcircled{1} a central processing unit (CPU) end transmits genes of each individual in the population to the GPU, and the genes are the decision variables;
\textcircled{2} a compute unified device architecture (CUDA) creates a resource required for computation;
\textcircled{3} each warp at a CUDA end is responsible for computing one current waveform, and a computation process is performed according to steps (1) to (8);
\textcircled{4} a computing resource is released; and
\textcircled{5} a computed waveform is transmitted back to the CPU end, and the fitness of each individual in the population is computed according to step (II).

8. A parallel electron swarm parameter calculation system taking ion dynamics into consideration, comprising:
a waveform measurement module configured to measure a discharge current waveform of gas under a reduced field intensity, and obtain a measured current waveform;
a model establishment module configured to establish an electron avalanche space-time development model of a coupled electron charge density and different types of ion charge densities;
a waveform computation module configured to compute the discharge current waveform of the gas under the reduced field intensity through a finite volume method according to the electron avalanche space-time development model, and obtain a computed current waveform; and
a parameter computation module configured to compute the electron swarm parameters of the gas under the reduced field intensity with a minimum deviation between the measured current waveform and the computed current waveform as an optimization target through a genetic algorithm.

9. A computer device, comprising a memory, a processor, and a computer program stored in the memory and runnable on the processor, wherein when the computer program is executed by the processor, steps of the method according to claim 1 are implemented.

10. A computer-readable storage medium, storing a computer program, wherein when the computer program is executed by a processor, steps of the method according to claim 1 are implemented.
